(19) United States
(12) Patent Application Publication
(10) Pub. No.: US 2015/0003246 A1
(43) Pub. Date: Jan. 1, 2015

(54) RADIO ACCESS NETWORK TRIGGERED BEARER MODIFICATION PROCEDURE

(71) Applicant: NOKIA SIEMENS NETWORKS OY, Espoo (FI)

(72) Inventors: Devaki CHANDRAMOULI, Plano, TX (US); Rainer LIEBHART, Munich (DE)

(21) Appl. No.: 13/929,065

(22) Filed: Jun. 27, 2013

(51) Int. Cl. H04L 5/00

(52) U.S. Cl. CPC H04L 5/0064
USPC 370/235; 370/329

(57) ABSTRACT

Bearer modification procedures may be of use in various communication systems. For example, a radio access network may benefit from being able to trigger a bearer modification procedure even in, for example, extreme situations or roaming situations. For example, a method can include identifying, at a radio access network element, that network conditions correspond to a predetermined criterion. The method can also include triggering a bearer modification procedure in response to identifying that the network conditions correspond to the predetermined criterion

### BACKGROUND

1. Field

Bearer modification procedures may be of use in various communication systems. For example, a radio access network may benefit from being able to trigger a bearer modification procedure even in, for example, extreme situations or roaming situations.

2. Description of the Related Art

The evolved packet system (EPS), the successor of general packet radio system (GPRS), provides radio interfaces and packet core network functions for broadband wireless data access. EPS core network functions include a mobility management entity (MME), a packet data network gateway (PDN-GW) and a serving gateway (S-GW). An example of an evolved packet core architecture is illustrated in FIG. 1 and is described by third generation partnership project (3GPP) technical specification (TS) 23.401, which is incorporated herein by reference in its entirety. A common packet domain core network can be used for both radio access networks (RANs), the global system for mobile communication (GSM) enhanced data rates for GSM evolution (EDGE) radio access network (GERAN) and the universal terrestrial radio access network (UTRAN). This common core network (CN) can provide general packet radio service (GPRS) services.

FIG. 2 illustrates an overall policy charging and control (PCC) architecture, including roaming with home routed access, when a subscription profile repository (SPR) is used. The PCC architecture can extend the architecture of an internet protocol connectivity access network (IP-CAN), where the policy and charging enforcement function (PCEF) is a functional entity in the Gateway node implementing the IP access to the packet data network (PDN).

As shown in FIG. 2, a home policy and charging rules function (H-PCRF) is connected to the PCEF, residing in a gateway, over Gx. The PCEF is connected to an offline charging system (OFCS) over Gz. The PCEF is connected to service data flow based credit control function in an online charging system (OCS) over Gy. The OCS is, in turn, connected to the H-PCRF over Sy. Rx connects the H-PCRF to an application server (AF), while Sp connects the H-PCRF to the SPR. A visited PCRF (V-PCRF), in a visited public land mobile network (VPLMN) can be connected to the H-PCRF, in the home public land mobile network (HPLMN) via S9. The V-PCRF may also be connected to a bearer binding and event reporting function (BBERF) over Gxx.

User plane congestion (UPCON) may be one issue addressed in 3GPP release 12. See, for example, 3GPP technical report (TR) 22.805 V12.1.0 (2012-12), which is hereby incorporated herein by reference. Increasing mobile data traffic growth in the market, for example due to smart phones, may create user plane congestion issues in the live network. User plane congestion causes network instability. Thus, operators may be faced with issues due to user plane congestion in the radio network, such as in the eNB or in the backhaul link between eNB and S-GW, for example on the S1-U interface.

User plane congestion scenarios can be of various kinds. A first kind of user plane congestion is due to full use of cell capacity. Another kind of user plane congestion is due to limited backhaul capacity, such as at the 3GPP RAN to an evolved packet core (EPC) interface, for example the S1-U interface.

In general, there may be pro-active and re-active solutions for user plane congestion. Pro-active solutions may be, for example, those in which the core network provides information to RAN about ongoing sessions such as their relative priority so that RAN takes measures once congestion occurs. Re-active may be, for example, those in which the RAN provides congestion information to the CN so that the CN takes appropriate measures. Appropriate measures may include measures such as limiting the bandwidth for certain bearers or applications, and applications can adapt/optimize content delivery. While these are the general categories of potential solutions, conventionally there remains a shortage of actual solutions, for example a shortage of reactive solutions.

Currently, 3GPP has defined procedures that allow UE to initiate bearer modification procedure, a home subscriber server (HSS) to initiate bearer modification procedure and PCRF/P-GW to initiate bearer modification procedure. See 3GPP TS 23.401, which is hereby incorporated herein by reference in its entirety. However, conventionally there is no ability for RAN to trigger bearer modification procedure under an extreme congested situation. According to current specifications, under extreme situations, eNB can release the GBR bearers that results in MME initiated bearer deactivation procedure. There is, however, no procedure available for the eNB to be able to trigger bearer modification for GBR and non-GBR bearers.

One reactive solution may be to report RAN load/congestion status information to the PCRF/AF, which in turn can result in a bearer modification procedure, such as blocking or compression, especially for streaming services. In the case of roamers, VPLMN operators may not want to expose their RAN congestion status to the HPLMN. Furthermore, the eNB may be unable to provide congestion information to the PCRF/AF due to lack of signaling messages triggered by, for example mobility events or lost user plane packets in which the load information is sent, such as in the case of an in-band solution. When such congestion information cannot be provided, then the PCRF may not be able to take action proactively. Under such extreme situations, eNB may have to resort to releasing GBR bearers, which can result in an MME-triggered bearer deactivation procedure. Alternatively, the eNB may drop packets.

### SUMMARY

According to certain embodiments, a method can include identifying, at a radio access network element, that network conditions correspond to a predetermined criterion. The method can also include triggering a bearer modification procedure in response to identifying that the network conditions correspond to the predetermined criterion.

In certain embodiments, a method can include receiving a message configured to trigger a bearer modification procedure in response to an identification, at a radio access network element, that network conditions correspond to a predetermined criterion. The method can also include forwarding the message as a command to a packet data network gateway configured to apply a locally configured quality of service policy or to interact with a policy and charging rules function to trigger a policy and charging control decision.

A method, according to certain embodiments, can include receiving a message configured to trigger a bearer modification procedure in response to an identification, at a radio access network element, that network conditions correspond to a predetermined criterion. The method can also include applying a locally configured quality of service policy or interacting with a policy and charging rules function to trigger a policy and charging control decision.

An apparatus, in certain embodiments, can include at least one processor and at least one memory including computer program code. The at least one memory and the computer program code can be configured to, with the at least one processor, cause the apparatus at least to identify, at a radio access network element, that network conditions correspond to a predetermined criterion. The at least one memory and the computer program code can also be configured to, with the at least one processor, cause the apparatus at least to trigger a bearer modification procedure in response to identifying that the network conditions correspond to the predetermined criterion.

According to certain embodiments, an apparatus can include at least one processor and at least one memory including computer program code. The at least one memory and the computer program code can be configured to, with the at least one processor, cause the apparatus at least to receive a message configured to trigger a bearer modification procedure in response to an identification, at a radio access network element, that network conditions correspond to a predetermined criterion. The at least one memory and the computer program code can also be configured to, with the at least one processor, cause the apparatus at least to forward the message as a command to a packet data network gateway configured to apply a locally configured quality of service policy or to interact with a policy and charging rules function to trigger a policy and charging control decision.

In certain embodiments, an apparatus can include at least one processor and at least one memory including computer program code. The at least one memory and the computer program code can be configured to, with the at least one processor, cause the apparatus at least to receive a message configured to trigger a bearer modification procedure in response to an identification, at a radio access network element, that network conditions correspond to a predetermined criterion. The at least one memory and the computer program code can also be configured to, with the at least one processor, cause the apparatus at least to apply a locally configured quality of service policy or interacting with a policy and charging rules function to trigger a policy and charging control decision.

An apparatus, according to certain embodiments, can include means for identifying, at a radio access network element, that network conditions correspond to a predetermined criterion. The apparatus can also include means for triggering a bearer modification procedure in response to identifying that the network conditions correspond to the predetermined criterion.

An apparatus, in certain embodiments, can include means for receiving a message configured to trigger a bearer modification procedure in response to an identification, at a radio access network element, that network conditions correspond to a predetermined criterion. The apparatus can also include means for forwarding the message as a command to a packet data network gateway configured to apply a locally configured quality of service policy or to interact with a policy and charging rules function to trigger a policy and charging control decision.

According to certain embodiments, an apparatus can include means for receiving a message configured to trigger a bearer modification procedure in response to an identification, at a radio access network element, that network conditions correspond to a predetermined criterion. The apparatus can also include means for applying a locally configured quality of service policy or interacting with a policy and charging rules function to trigger a policy and charging control decision.

In certain embodiments, a non-transitory computer-readable medium can be encoded with instructions that, when executed in hardware, perform a process. The process can include identifying, at a radio access network element, that network conditions correspond to a predetermined criterion. The process can also include triggering a bearer modification procedure in response to identifying that the network conditions correspond to the predetermined criterion.

A non-transitory computer-readable medium can, according to certain embodiments, be encoded with instructions that, when executed in hardware, perform a process. The process can include receiving a message configured to trigger a bearer modification procedure in response to an identification, at a radio access network element, that network conditions correspond to a predetermined criterion. The process can also include forwarding the message as a command to a packet data network gateway configured to apply a locally configured quality of service policy or to interact with a policy and charging rules function to trigger a policy and charging control decision.

A non-transitory computer-readable medium can, in certain embodiments, be encoded with instructions that, when executed in hardware, perform a process. The process can include receiving a message configured to trigger a bearer modification procedure in response to an identification, at a radio access network element, that network conditions correspond to a predetermined criterion. The process can also include applying a locally configured quality of service policy or interacting with a policy and charging rules function to trigger a policy and charging control decision.

A system, according to certain embodiments, can include a first apparatus, a second apparatus, and a third apparatus. The first apparatus can include means for identifying, at a radio access network element, that network conditions correspond to a predetermined criterion. The first apparatus can also include means for triggering a bearer modification procedure in response to identifying that the network conditions correspond to the predetermined criterion. The second apparatus can include means for receiving, from the first apparatus, the message configured to trigger a bearer modification procedure in response to an identification, at a radio access network element, that network conditions correspond to a predetermined criterion. The second apparatus can also include means for forwarding the message as a command to the third apparatus. The third apparatus can include means for receiving the message configured to trigger a bearer modification procedure in response to an identification, at a radio access network element, that network conditions correspond to a predetermined criterion. The third apparatus can also include means for applying a locally configured quality of service policy or interacting with a policy and charging rules function to trigger a policy and charging control decision.

### BRIEF DESCRIPTION OF THE DRAWINGS

For proper understanding of the invention, reference should be made to the accompanying drawings, wherein:

FIG. 1 illustrates an example of an evolved packet core architecture.

FIG. 2 illustrates an overall policy charging and control architecture, including roaming with home routed access, when a subscription profile repository is used.

FIG. 3 illustrates a signal flow according to certain embodiments.

FIG. 4 illustrates a method according to certain embodiments.

FIG. 5 illustrates a system according to certain embodiments.

### DETAILED DESCRIPTION

Depending on the congestion situation, allocating reduced quality of service (QoS)/radio resources, such as reduced bandwidth, per connected user equipment (UE) may be sufficient to address radio access network (RAN) congestion. Especially in roaming situations, it may be beneficial if the visited eNB does not have to send the congestion information to the home PLMN, but instead the eNB can trigger the bearer modification by itself by providing QoS modification parameters. In the following, re-active solutions are discussed, although it should be understood that pro-active solutions are not excluded.

Conventional approaches require that the P-GW/PCRF support new functionality, such as understand eNB load level, specified in release 12. Thus, conventional approaches require an upgrade of the P-GW/PCRF. By contrast, certain embodiments do not assume support for any additional functionality in the P-GW or PCRF, such as rel-12. Thus, modifications may be made instead to the eNB/MME to support this procedure. Thus, certain embodiments may work with legacy P-GW/PCRF, which is not the case with conventional approaches.

According to certain embodiment, an eNB in a Long Term Evolution (LTE) radio access network (RAN) can trigger a bearer modification procedure in order to reduce radio access network congestion under extreme situations. The eNB can modify one of the Evolved Packet System (EPS) bearer QoS parameters or modify the UE Aggregate Maximum Bit Rate (UE-AMBR). The EPS bearer QoS parameters can include, for example, QoS Class Identifier (QCI), GBR, Maximum Bit Rate (MBR) or Allocation and Retention Priority (ARP).

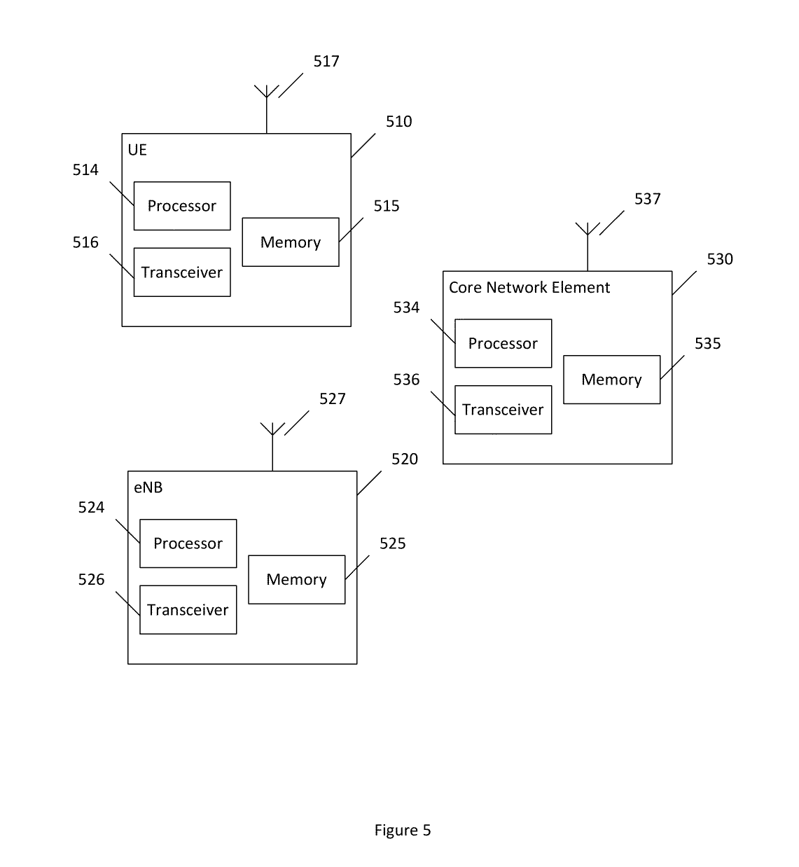

When an eNB is internally triggered due to congestion, the eNB can request bearer QoS modification by initiating a “Request bearer modification” message towards the MME. The message may be forwarded to the Serving Gateway (S-GW) and eventually to the Packet Data Network Gateway (P-GW or PDN GW), which may either apply a locally configured QoS policy, or may interact with the Policy and Charging Rules Function (PCRF) to trigger the appropriate Policy and Charging Control (PCC) decision. The PCC decision may take into account subscription information. The procedure in the home core network may in certain aspects resemble the bearer modification procedure as specified in 3GPP TS 23.401 (FIG. 5.4.5-1).

Conventionally, all the bearer modification initiated by the network specified in TS 23.401 assumes bearer modification triggered by HPLMN based on subscription, policy change, application traffic or the like. For example, the modification may be PDN-GW initiated bearer modification or HSS initiated bearer modification via MME. By contrast, certain embodiments provide a procedure that can be triggered by VPLMN, although embodiments do not need to be limited to triggering by VPLMN. There may also be UE-based triggers, such as by a roaming UE in VPLMN or by a non-roaming UE residing in HPLMN.

Moreover, while QoS modification is specified in TS 23.401, the triggers for such modification are not due to User Plane (UP) congestion in the RAN. At this time, the RAN simply drops the bearer under such extreme situations.

For example, radio bearers for the UE in the ECM-CONNECTED state may be released due to local reasons. For example, abnormal resource limitation or radio conditions may not allow the eNodeB to maintain all the allocated GBR bearers. Conventionally, it is not expected that non-GBR bearers are released by the eNodeB unless caused by error situations. The UE, in this case, deletes the bearer contexts related to the released radio bearers.

When the eNodeB releases radio bearers in the operation just described, it can send an indication of bearer release to the MME. This indication may be, for example, a bearer release request message to the MME, the message containing EPS bearer identity. Alternatively the indication can be an initial context setup complete, handover request Ack and UE context response, or path switch request.

By contrast, certain embodiments provide procedures and solutions that may allow a radio access network to trigger a bearer modification procedure. These procedures and solutions may help to alleviate RAN congestion under extreme situations. Moreover, these procedures and solutions may help avoid a VPLMN exposing a RAN congestion status, such as load information, to an HPLMN in roaming situations. Furthermore, such procedures and solutions could help radio access network avoid releasing GBR bearers and rejecting new requests from high priority users and for emergency services.

Such procedures can be used by the eNB to modify one of the EPS bearer QoS parameters, such as QCI, GBR, MBR or ARP, or to modify UE-AMBR. This may be triggered by the eNB only under extreme situations when radio resources cannot be maintained for all the allocated bearers. This could also be triggered by the eNB when RAN congestion has been alleviated and the originally requested QoS can be provided to the UE, for example to increase the EPS bearer QoS parameters.

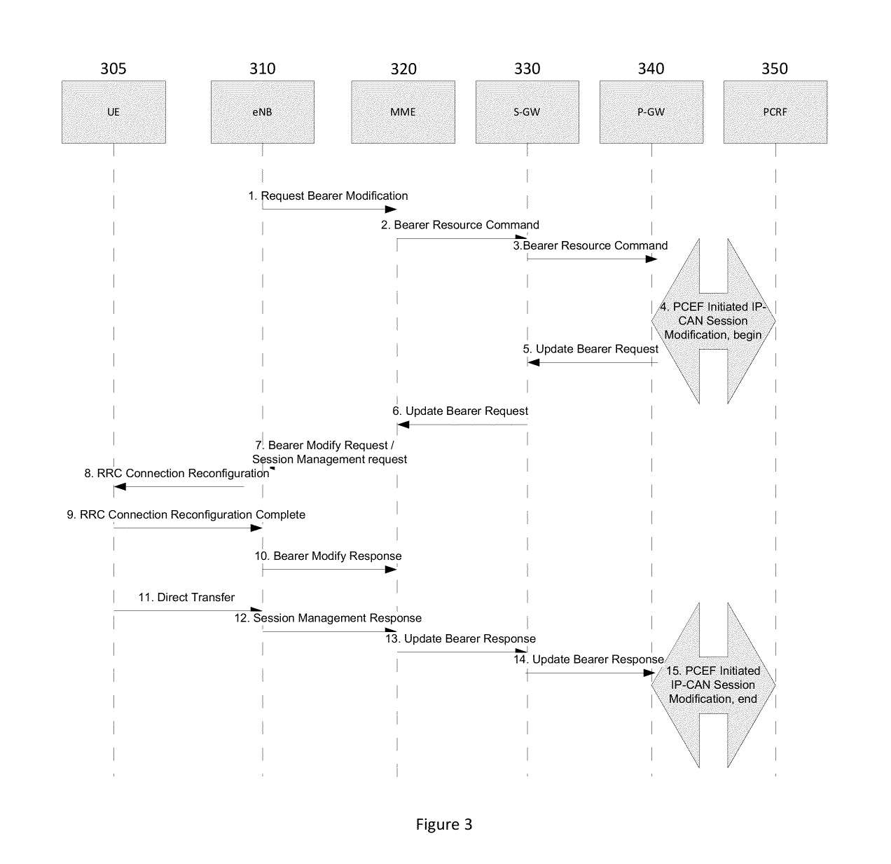

FIG. 3 illustrates a signal flow according to certain embodiments. As shown in FIG. 3, at 1 eNB 310 can request a bearer QoS modification, which may be a new procedure triggered by eNB 310 internal measures, by initiating a request bearer modification message towards the MME 320. The message can include the IMSI, EPS bearer identity, linked EBI, and modified QoS parameters, such as QCI, ARP, and UE-AMBR.

At 2, MME 320 can receive the messages and can construct a bearer resource command based on the parameters received from eNB 310 and the UE context stored within the MME 320. The bearer resource command can include IMSI, LBI, EPS Bearer Identity, and QoS in the message sent to the S-GW 330. The MME 320 can validate the request using the linked bearer Id. The same serving GW address can be used by the MME 320 as used for the EPS bearer identified by the linked bearer Id received in the request bearer resource modification message.

At 3, the S-GW 330 can send a bearer resource command message to the P-GW 340. The message can include IMSI, LBI, EPS bearer identity, and QoS. The S-GW 330 can send the message to the same P-GW 340 as for the EPS bearer identified by the linked bearer Id.

At 4, the P-GW 340 may either apply a locally configured QoS policy, or it may interact with the PCRF 350 to trigger the appropriate PCC decision, which may take into account subscription information. The P-GW 340 can generate the TFT and can update the EPS bearer QoS to match the traffic flow aggregate. When interacting with PCRF 350, the P-GW 340 can provide the PCRF 350 with the GBR change associated with the packet filter information. The change may be an increase or a decrease. The GBR change can be calculated from the bearer QoS provided by the S-GW 330 and the current bearer QoS.

At 5, the P-GW 340 can use this QoS policy to determine that the authorized QoS of a service data flow has changed or that a service data flow is to be aggregated to or removed from an active bearer. The P-GW 340 can then send the update bearer request message to the S-GW 330. The update bearer request message can include EPS bearer identity, EPS bearer QoS, APN-AMBR, and TFT.

At 6, the S-GW 330 can send the update bearer request message to the MME 320. The update bearer request message can include PTI, EPS bearer identity, EPS bearer QoS, TFT, and APN AMBR. If the UE 305 is in ECM-IDLE state, MME 320 can page the UE 305, which can trigger a service request. If ARP is the only QoS parameter modified and if the UE 305 is in ECM IDLE state, then the MME 320 can skip the network triggered service request. In that case, the following steps 7-12 may also be skipped and the MME 320 can send an update bearer response to the S-GW 330.

At 7, the MME 320 can build a session management request including the PTI, EPS Bearer QoS parameters (excluding ARP), TFT, APN AMBR, and EPS bearer identity. If the UE 305 has UTRAN or GERAN capabilities and the network supports mobility to UTRAN or GERAN, the MME 320 can use the EPS bearer QoS parameters to derive the corresponding PDP context parameters, including QoS negotiated (R99 QoS profile), radio priority, and packet flow Id. The MME 320 can include these parameters in the session management request. If the UE 305 indicated in the UE network capability that it does not support BSS packet flow procedures, then the MME 320 may omit including the packet flow Id. If the APN AMBR has changed, the MME 320 may update the UE AMBR if appropriate. The MME 320 can then send a bearer modify request message to the eNB 310. The request message can include EPS bearer identity, EPS bearer QoS, session management request, and UE AMBR.

At 8, the eNB 310 can map the modified EPS Bearer QoS to the Radio Bearer QoS. The eNB 310 can then signal a RRC connection reconfiguration message to the UE 305. The reconfiguration message can include radio bearer QoS, session management request, and EPS RB identity. The UE 305 may store the QoS negotiated, radio priority, and packet flow Id, which it received in the session management request, for use when accessing via GERAN or UTRAN. If the APN-AMBR has changed, the UE 305 can store the modified APN-AMBR value and can set the MBR parameter of the corresponding non-GBR PDP contexts of this PDN connection to the new value. The UE 305 can use an uplink packet filter, such as UL TFT, to determine the mapping of traffic flows to the radio bearer. The UE 305 may provide EPS bearer QoS parameters to the application handling the traffic flow(s). The UE 305 may avoid rejecting the radio bearer modify request on the basis of the EPS bearer QoS parameters contained in the session management request.

At 9, the UE 305 can acknowledge the radio bearer modification to the eNB 310 with a RRC connection reconfiguration complete message.

At 10, the eNB 310 can acknowledge the bearer modification to the MME 320 with a bearer modify response message including EPS bearer identity. The MME 320 may receive this message either before or after the session management response message, which may be sent in step 11.

At 11, the UE NAS layer can build a session management response including EPS bearer identity. The UE 305 can then send a direct transfer message to the eNB 310. The direct transfer message can include a session management response.

At 12, the eNB 310 can send an uplink NAS transport message to the MME 320. The NAS transport message can include a session management response.

At 13, upon reception of the bearer modify response message in step 10 and the session management response message in step 12, the MME 320 can acknowledge the bearer modification to the S-GW 330 by sending an update bearer response message. The update bearer response message can include EPS bearer identity and user location information, such as enhanced cell global identity (ECGI). If the bearer modification was triggered by the eNB 310, steps 13-15 can be skipped.

At 14, the S-GW 330 can acknowledge the bearer modification to the P-GW 340 by sending an update bearer response message. The update bearer response message can include EPS bearer identity and user location information, such as ECGI.

At 15, if the P-GW 340 interacted with the PCRF 350 in step 4, the P-GW 340 can indicate to the PCRF 350 whether the PCC decision could be enforced or not.

There may be various advantages and benefits to certain embodiments of the present application. For example, in certain embodiments the eNB 310 may be able to trigger a bearer modification procedure. This could be beneficial in roaming scenarios when RAN congestion information cannot be exposed towards the home network and when PCRF has failed to update bearer QoS by itself based on a RAN congestion status. Under extreme congestion situations, eNB 310 may have the ability to guard its own resources and loss of bearer does not need to be the only option available to the eNB 310. Thus, certain embodiments could help radio access network avoid releasing GBR bearers and rejecting new requests from high priority users and for emergency services.

Certain embodiments may be particularly beneficial when a UE is roaming, for example when a VPLMN can trigger the procedure. Also, certain embodiments may be helpful in non-roaming scenarios for certain use cases, such as with legacy P-GW/PCRF nodes. Thus, both roaming and non-roaming scenarios may be included in various embodiments.

Moreover, under extreme congestion situations, certain embodiments may provide the eNB with the ability to guard its own resources and trigger bearer resource modification. Thus, loss of bearer does not need to be the only option available to the eNB. Similar procedure can also be used to accomplish the reverse, such as triggering bearer modification to increase the QoS when additional resources are available.

Reducing user plane congestion may have increasing benefit due to traffic growth. Thus, certain embodiments may improve network stability in a live network.

Furthermore, RAN triggered bearer modification procedures may permit immediate action, such as response from the core network. By contrast, cell congestion status provided to the PCRF/AS may have to occur on a periodic basis, as it may not be known to the RAN when PCRF/AS will take actions for bearer modification.

Various further use cases are also possible. For example, one possibility is to enable modification of GBR to non-GBR. In other embodiments, however, the procedure may involve a request for modification of any of the allocated QoS parameters, such as QCI, ARP, UE-MBR, MBR, or GBR.

While roamers may occupy significant amount of resources in their network and congestion/overload may be mainly due to roamers, the roaming scenario is just one example. Another example may include where the PCRF/AS is not deployed within the operator's network and the operator does not want to expose cell congestion status to such entities. Also, in case of network sharing, the RAN may be shared by multiple operators.

While congestion may be one reason to trigger procedures according to certain embodiments, there may be other use cases. For example, the procedures can be used in case there is a change in traffic pattern detected in the VPLMN. Other use cases are not excluded.

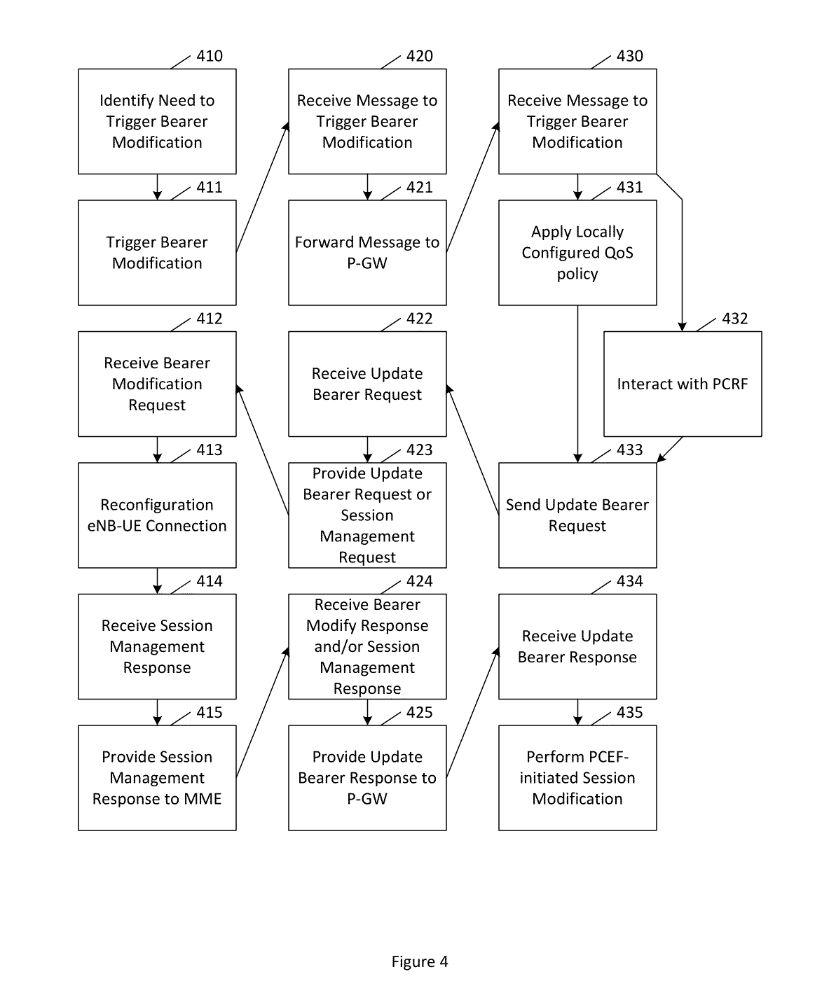

FIG. 4 illustrates a method according to certain embodiments. As shown in FIG. 4, a method can include, at 410, identifying, at a radio access network (RAN) element, that network conditions correspond to a predetermined criterion. The criterion can be a level of congestion. For example, the RAN element can determine that congestion is above a threshold or below a threshold. The congestion may, for example, be due to at least one roaming user equipment that is currently within a coverage area of the RAN element. The RAN element may be a base station, such as an eNode B or wireless local area network (WLAN) access point (AP). Thus, the RAN element can be an element other than a terminal or user equipment device and other than a core network element.

The method can also include, at 411, triggering a bearer modification procedure in response to identifying that the network conditions correspond to the predetermined criterion. The bearer modification procedure is configured to alter the level of congestion. For example, the bearer modification procedure can be designed to alleviate congestion. Alternatively, if desired, the bearer modification procedure can be designed to increase congestion. Moreover, the bearer modification can be a modification other than simply releasing bearers.

The bearer modification procedure can include modifying a quality of service parameter or an aggregate maximum bit rate. The quality of service parameter can include at least one of a quality of service class identifier, guaranteed bit rate, maximum bit rate, or allocation and retention priority.

The triggering can include sending a request bearer modification toward a mobility management entity. Thus, at 412, the method can also include, in response to the request, receiving at least one of a bearer modification request or a session management request. The method can further include, at 413, reconfiguring a connection between a base station and a user equipment based on the at least one of the bearer modification request or the session management request.

Moreover, at 414, the method can include receiving a session management response from the user equipment. The method can also include, at 415, providing the session management response to a mobility management entity.

The method can additionally include, at 420, receiving a message configured to trigger a bearer modification procedure in response to an identification, at a radio access network element, that network conditions correspond to a predetermined criterion. In other words, this can be the message sent at 411, above. The method can further include, at 421, forwarding the message as a command to a packet data network gateway configured to apply a locally configured quality of service policy or to interact with a policy and charging rules function to trigger a policy and charging control decision.

Moreover, at 422, the method can include receiving an update bearer request in response to the command. The method can also include, at 423, providing at least one of a bearer modification request or a session management request to a base station.

Furthermore, at 424, the method can include receiving a bearer modify response in response to the bearer modification request, or receiving a session management response in response to the session management request, or receiving both the bearer modify response and the session management response. This can be, for example, the response sent at 415 above.

At 425, the method can also include providing an update bearer response to the packet data network gateway based on at least one of the bearer modification response or the session management response.

Additionally, the method can include, at 430, receiving a message configured to trigger a bearer modification procedure in response to an identification, at a radio access network element, that network conditions correspond to a predetermined criterion. This can be the message sent at 421 above. The method can also include, at 431, applying a locally configured quality of service policy or, at 432, interacting with a policy and charging rules function to trigger a policy and charging control decision. The method can also include, at 433, sending an update bearer request to a mobility management entity in response to the message.

At 434, the method can include receiving an update bearer response in response to the update bearer request. Also, at 435, the method can include performing a policy and charging enforcement function initiated session modification.

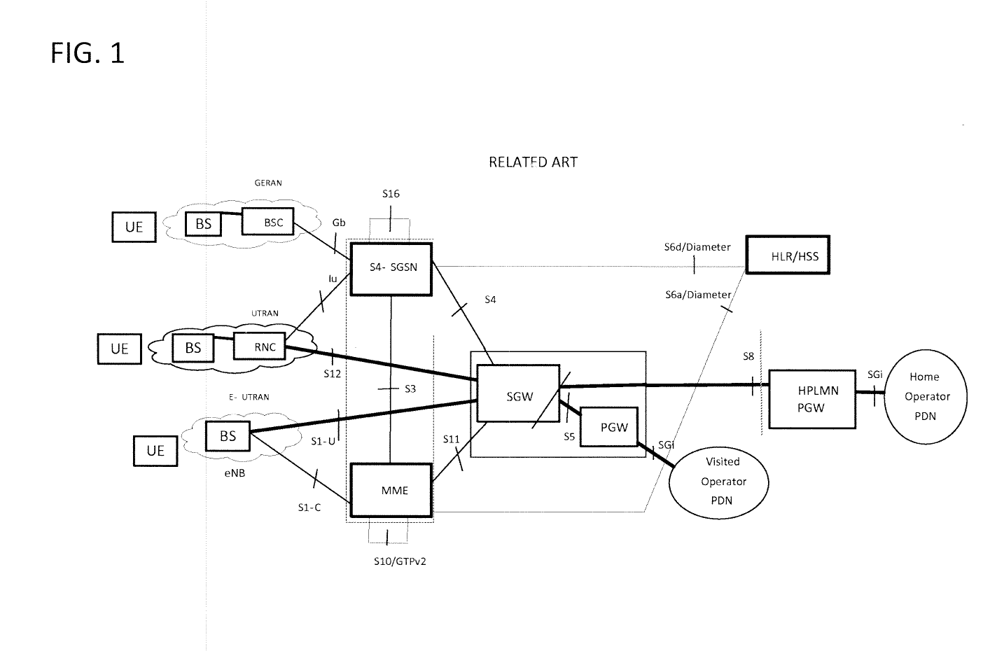

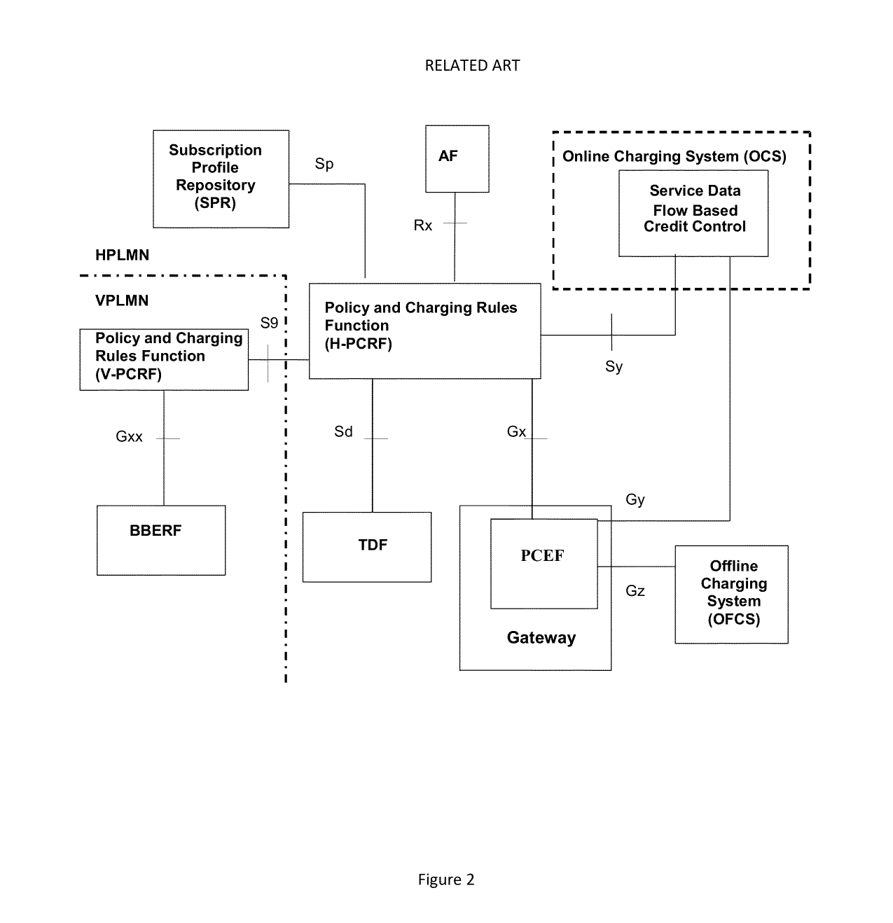

FIG. 5 illustrates a system according to certain embodiments of the invention. In one embodiment, a system may include multiple devices, such as, for example, at least one UE 510, at least one eNB 520 or other base station or access point, and at least one core network element 530. The core network element 530 is shown as a single device, but there may be a variety of core network devices, for example as shown in FIGS. 1-3.

Each of these devices may include at least one processor, respectively indicated as 514, 524, and 534. At least one memory can be provided in each device, and indicated as 515, 525, and 535, respectively. The memory may include computer program instructions or computer code contained therein. The processors 514, 524, and 534 and memories 515, 525, and 535 can be configured to provide means corresponding to the various blocks of FIG. 4.

As shown in FIG. 5, transceivers 516, 526, and 536 can be provided, and each device may also include an antenna, respectively illustrated as 517, 527, and 537. Other configurations of these devices, for example, may be provided. For example, core network element 530 may be configured for wired communication, rather than wireless communication, and in such a case antenna 537 would illustrate any form of communication hardware, without requiring a conventional antenna.

Transceivers 516, 526, and 536 can each, independently, be a transmitter, a receiver, or both a transmitter and a receiver, or a unit or device that is configured both for transmission and reception.

Processors 514, 524, and 534 can be embodied by any computational or data processing device, such as a central processing unit (CPU), application specific integrated circuit (ASIC), or comparable device. The processors can be implemented as a single controller, or a plurality of controllers or processors.

Memories 515, 525, and 535 can independently be any suitable storage device, such as a non-transitory computer-readable medium. A hard disk drive (HDD), random access memory (RAM), flash memory, or other suitable memory can be used. The memories can be combined on a single integrated circuit as the processor, or may be separate from the one or more processors. Furthermore, the computer program instructions stored in the memory and which may be processed by the processors can be any suitable form of computer program code, for example, a compiled or interpreted computer program written in any suitable programming language.

The memory and the computer program instructions can be configured, with the processor for the particular device, to cause a hardware apparatus such as UE 510, eNB 520, and core network element 530, to perform any of the processes described above (see, for example, FIGS. 3 and 4). Therefore, in certain embodiments, a non-transitory computer-readable medium can be encoded with computer instructions that, when executed in hardware, perform a process such as one of the processes described herein. Alternatively, certain embodiments of the invention can be performed entirely in hardware.

Furthermore, although FIG. 5 illustrates a system including a UE, eNB, and core network element, embodiments of the invention may be applicable to other configurations, and configurations involving additional elements, as illustrated herein, for example in FIGS. 1-3.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims

### GLOSSARY

3GPP—Third Generation Partnership Project

AP—Access Point

APN—Access Point Name

APN-AMBR—APN Aggregate Maximum Bit Rate

ARP—Allocation and Retention Priority

ASIC—Application Specific Integrated Circuit

BBERF—Bearer Binding and Event Reporting Function

CN—Core Network

CPU—Central Processing Unit

EDGE—Enhanced Data Rates for GSM Evolution

eNB—Enhanced NodeB

EPC—Evolved Packet Core

EPS—Evolved Packet System

GBR—Guaranteed Bit Rate

GERAN—GSM EDGE Radio Access Network

GPRS—General Packet Radio System

GSM—Global System for Mobile Communication

H-—Home

HSS—Home Subscriber Server

IP-CAN—Internet Protocol Connectivity Access Network

MBR—Maximum Bit Rate

MME—Mobility Management Entity

OCS—Online Charging System

OFCS—Offline Charging System

PCC—Policy Charging and Control

PCEF—Policy and Charging Enforcement Function

PCRF—Policy and Charging Rules Function

PDN—Packet Data Network

P-GW—Packet Data Network Gateway

PLMN—Public Land Mobile Network

QCI—QoS Class Identifier

QoS—Quality of Service

RAN—Radio Access Network

S-GW—Serving Gateway

SPR—Subscription Profile Repository

TR—Technical Report

TS—Technical Specification

UE—User Equipment

UP—User Plane

UPCON—User Plane Congestion

V-—Visited

WLAN—Wireless Local Area Network

We claim:

1. A method, comprising:
identifying, at a radio access network element, that network conditions correspond to a predetermined criterion; and
triggering a bearer modification procedure in response to identifying that the network conditions correspond to the predetermined criterion.

2. The method of claim 1, wherein the criterion is a level of congestion.

3. The method of claim 2, wherein the bearer modification procedure is configured to alter the level of congestion.

4. The method of claim 1, wherein the bearer modification procedure comprises modifying a quality of service parameter or an aggregate maximum bit rate.

5. The method of claim 4, wherein the quality of service parameter includes at least one of a quality of service class identifier, guaranteed bit rate, maximum bit rate, or allocation and retention priority.

6. The method of claim 1, wherein the triggering comprises sending a request bearer modification toward a mobility management entity.

7. The method of claim 1, further comprising:
receiving at least one of a bearer modification request or a session management request; and
reconfiguring a connection between a base station and a user equipment based on the at least one of the bearer modification request or the session management request.

8. The method of claim 7, further comprising:
receiving a session management response from the user equipment; and
providing the session management response to a mobility management entity.

9. The method of claim 1, wherein the triggering the bearer modification procedure is performed by a visited radio access network.

10. A method, comprising:
receiving a message configured to trigger a bearer modification procedure in response to an identification, at a radio access network element, that network conditions correspond to a predetermined criterion; and
forwarding the message as a command to a packet data network gateway configured to apply a locally configured quality of service policy or to interact with a policy and charging rules function to trigger a policy and charging control decision.

11. The method of claim 10, further comprising:
receiving an update bearer request in response to the command; and
providing at least one of a bearer modification request or a session management request to a base station.

12. The method of claim 11, further comprising:
receiving a bearer modify response in response to the bearer modification request, or receiving a session management response in response to the session management request, or receiving both the bearer modify response and the session management response; and
providing an update bearer response to the packet data network gateway based on at least one of the bearer modification response or the session management response.

13. A method, comprising:
receiving a message configured to trigger a bearer modification procedure in response to an identification, at a radio access network element, that network conditions correspond to a predetermined criterion; and
applying a locally configured quality of service policy or interacting with a policy and charging rules function to trigger a policy and charging control decision.

14. The method of claim 13, further comprising:
sending an update bearer request to a mobility management entity in response to the message.

15. The method of claim 14, further comprising:
receiving an update bearer response in response to the update bearer request; and
performing a policy and charging enforcement function initiated session modification.

16. An apparatus, comprising:
at least one processor; and
at least one memory including computer program code,
wherein the at least one memory and the computer program code are configured to, with the at least one processor, cause the apparatus at least to
identify, at a radio access network element, that network conditions correspond to a predetermined criterion; and
trigger a bearer modification procedure in response to identifying that the network conditions correspond to the predetermined criterion.

17. The apparatus of claim 16, wherein the criterion is a level of congestion.

18. The apparatus of claim 17, wherein the bearer modification procedure is configured to alter the level of congestion.

19. The apparatus of claim 16, wherein the bearer modification procedure comprises modifying a quality of service parameter or an aggregate maximum bit rate.

20. The apparatus of claim 19, wherein the quality of service parameter includes at least one of a quality of service class identifier, guaranteed bit rate, maximum bit rate, or allocation and retention priority.

21. The apparatus of claim 16, wherein the at least one memory and the computer program code are configured to, with the at least one processor, cause the apparatus at least to trigger by sending a request bearer modification toward a mobility management entity.

22. The apparatus of claim 16, wherein the at least one memory and the computer program code are configured to, with the at least one processor, cause the apparatus at least to
receive at least one of a bearer modification request or a session management request; and
reconfigure a connection between a base station and a user equipment based on the at least one of the bearer modification request or the session management request.

23. The apparatus of claim 22, wherein the at least one memory and the computer program code are configured to, with the at least one processor, cause the apparatus at least to
receive a session management response from the user equipment; and
provide the session management response to a mobility management entity.

24. The apparatus 16, wherein the apparatus is configured to trigger the bearer modification procedure while configured as an element of a visited radio access network.

25. An apparatus, comprising:
at least one processor; and
at least one memory including computer program code,
wherein the at least one memory and the computer program code are configured to, with the at least one processor, cause the apparatus at least to
receive a message configured to trigger a bearer modification procedure in response to an identification, at a radio access network element, that network conditions correspond to a predetermined criterion; and
create and forward the message as a command to a serving gateway and eventually to a packet data network gateway configured to apply a locally configured quality of service policy or to interact with a policy and charging rules function to trigger a policy and charging control decision.

26. The apparatus of claim 25, wherein the at least one memory and the computer program code are configured to, with the at least one processor, cause the apparatus at least to
receive an update bearer request in response to the command; and
provide at least one of a bearer modification request or a session management request to a base station.

27. The apparatus of claim 26, wherein the at least one memory and the computer program code are configured to, with the at least one processor, cause the apparatus at least to
receive a bearer modify response in response to the bearer modification request, or receiving a session management response in response to the session management request, or receiving both the bearer modify response and the session management response; and
provide an update bearer response to the packet data network gateway based on at least one of the bearer modification response or the session management response.

28. An apparatus, comprising:
at least one processor; and
at least one memory including computer program code,
wherein the at least one memory and the computer program code are configured to, with the at least one processor, cause the apparatus at least to
receive a message configured to trigger a bearer modification procedure in response to an identification, at a radio access network element, that network conditions correspond to a predetermined criterion; and
apply a locally configured quality of service policy or interacting with a policy and charging rules function to trigger a policy and charging control decision.

29. The apparatus of claim 28, wherein the at least one memory and the computer program code are configured to, with the at least one processor, cause the apparatus at least to send an update bearer request to a mobility management entity in response to the message.

30. The apparatus of claim 29, wherein the at least one memory and the computer program code are configured to, with the at least one processor, cause the apparatus at least to
receive an update bearer response in response to the update bearer request; and
perform a policy and charging enforcement function initiated session modification.
